(19) United States
(12) Patent Application Publication
(10) Pub. No.: US 2006/0054485 A1
(43) Pub. Date: Mar. 16, 2006

(54) Solar/heat powered distillation device

(76) Inventor: John Michael McGonigle, Fountain Hills, AZ (US)

Correspondence Address: John M. McGonigle, 16109 E. Trevino Dr., Fountain Hills, AZ, 85268, US

(21) Appl. No.: 10/941,516

(22) Filed: Sep. 14, 2004

(51) Int. Cl. B01D 3/14

(52) U.S. Cl. 202/155; 202/185.3; 202/201; 202/234; 202/172

(57) ABSTRACT

A solar powered distillation system without the need for any moving parts. Air from the atmosphere enters an evaporator (FIG. 2. parts 1,2, and 4) and passes over seawater (FIG. 2., contained in part 3) that is heated by sunlight. As the air increases in temperature and humidity, it becomes less dense. The air then enters a condensation structure (FIG. 2, part 6). Buoyancy forces allow the air to rise through the condensation structure and exit to the atmosphere through an outlet at the top of the condensation structure. While passing through the condensation structure, the air loses heat energy to the structure and water vapor condenses on its inner surface. The condensation then flows down the inner surface of the condensate collector into a container of fresh water (FIG. 2, part 7). The distiller can also be heated by a source of energy other than the sun, and can be used to distill volatile liquids other than water.

### CROSS-REFERENCE TO RELATED APPLICATIONS Not Applicable

### FEDERALLY SPONSORED RESEARCH Not Applicable

### SEQUENCE LISTING OR PROGRAM Not Applicable

### BACKGROUND OF THE INVENTION

1. Field of the Invention

This invention relates to the distillation of liquids, specifically the distillation of seawater and brine for the purpose of desalinization, and the distillation of dirty water for the purpose of purification.

2. Discussion of Prior Art

There are many areas of the earth with abundant amounts of sunlight and non-potable water. Such areas include arid regions on or around oceans and salt lakes. In such arid regions, fresh water and the money with which to obtain fresh water may be very limited. In regions like these, a simple inexpensive solar distiller would be extremely useful.

There are several know methods to use solar energy to distill water. These designs vary greatly in complexity and effectiveness. One relatively simple but effective design has been used by the El Paso Solar Energy Association (http://www.txses.org/epsea/stills.html). This design is a solar oven that collects water that condenses an inner surface of the oven. There are several modifications of this design in existence, all of which collect condensate that forms on the inside of the structure in which water is heated. These designs are simple, but they have two primary disadvantages that slow the rate at which they are able to distill. First, the water condenses onto part of the heated solar oven. Since water condenses on a heated surface, the rate of condensation is slower than it would be if water were allowed to condense on a non-heated surface. A second drawback to these designs is that water is evaporated into air that is very nearly saturated with water. Since water evaporates into dry air faster than it evaporates into humid air, and this decreases the rate at which evaporation occurs.

There are several other more complex devices that are intended to distill salt water using energy from the sun. Unfortunately, many of these devices are so complex that they are difficult and expensive to build. They often require exotic materials, complex construction, and sometimes require the use of electrical devices. These complexities can make these devices un-economical for many people, and un-obtainable for people in remote and third world regions were the materials and electricity required to build and operate these devices are unavailable. Some examples of prior art with parts that either require electricity or are non-common and difficult to find or build in remote areas are:
U.S. Pat. No. 4,756,802 which requires lenses and concentrators
U.S. Pat. No. in 6,761,802 and U.S. Pat. No. 4,921,580 which require vacuum pumps
U.S. Pat. No. 5,672,250 which required the creation of airlocks

### BACKGROUND OF THE INVENTION—OBJECTS AND ADVANTAGES

Several objects and advantages of the present invention are:
(a) to provide a distilling device capable of distilling salt water or other liquids that is of simple design and has no moving parts;
(b) to provide a distilling device that does not require electric power, and can instead be powered by sunlight or another heat source;
(c) to provide a distilling device that can be easily constructed from common materials;
(d) to provide a distilling device that can evaporate the desired liquid more efficiently than other designs of comparable simplicity;
(e) to provide a distilling device that allows for vaporized liquid to condense rapidly;
(f) to provide a distilling device that operates at a lower temperature than comparable designs, leading to less heat loss due to radiation and convection;
(g) to provide a distilling device with heat and mass transfer capabilities that are improved by the movement of air through the device;
(h) to provide a distilling device of versatile design that will allow for a number of ways to improve performance, so that builders and users can customize a design that works best for them;

### SUMMARY

A simple embodiment of the distiller comprises of three main parts, and is described in this summary. These three main parts are an evaporator, a condensate collector, and a condensing structure. A variety of other parts serving different functions can be added to the three base parts to improve performance.

The evaporator will contain salt water that is heated by an external source, such as the sun. Air will enter the evaporator from outside of the invention and pass over salt water that is to be distilled. The heat source will heat the air and cause the salt water to evaporate. The air will become warmer and more humid as it passes through the evaporator, causing it to become less dense than ambient air. The warm humid air will then exit the evaporator and enter the condensate collector.

The condensate collector is a container with two holes; one hole acts an inlet to let in warm humid air from the evaporator, and one hole acts as an outlet for this same humid air. The warm humid air will pass through the condensate collector and enter the vertical or upward sloping condensing structure.

As the warm humid air rises through the relatively colder condensing structure, it loses heat energy to the structure. This thermal energy loss causes water vapor in the warm humid air to condense and form droplets on the wall of the condensing structure. The droplets then drip down the condensing structure and fall into the condensate collector. Condensed water collects at the bottom of the condensate collector. The air continues to rise through the top of the condensing structure and exits the invention.

### DRAWINGS—FIGURES

FIG. 1 shows an overview of the preferred embodiment of the invention. It shows that the condensation structure (part 6) does not need to be vertical but rather should have an exit that is higher than its inlet.

FIG. 2 is a close-up view of the preferred embodiment. The condensation structure (part 6) is only partially shown.

FIG. 3 is a modification of the preferred embodiment with two added parts: Part 8 which allows the air to avoid having to flow through the condensate collector, and part 9 which is a pipe that prevents heated air from escaping through the air inlet when the evaporator is first heated.

FIG. 4 is an overview of a distiller that can be heated by an external heat source. The kettle 10 can be filled with liquid to be distilled and can be heated over a stove or fire. Air that exits the condensation structure 13 enters a second condensation collector 14 and is re-circulated into the evaporator. Air flows counter-clockwise; warmer air rises on the right and cooler air sinks on the left.

### DRAWINGS—REFERENCE NUMERALS

1—Cardboard box.
2—Hole in cardboard box that acts as an air inlet to the evaporator.
3—Frying pan to hold liquid to be distilled.
4—Glass covering cardboard box.

Parts 1-4 are the parts that make the evaporator.
5—Passageway to allow air to flow from the evaporator to the condensing structure.
7—Condensing structure, in this case PVC hose hung from a structure that is not shown.
8—3 way pipe connector.
9—hose to prevent hot air from escaping the evaporator when the distiller is warming up.
10—a metal kettle
11—a pipe that allows air and vapor to flow from part 10 to part 12
12—a container to collect condensate
13—a copper pipe for a condensation structure.
14—a second condensation collector that collects vapor that condenses in the cold section of the pipe.

### DETAILED DESCRIPTION—PREFERRED EMBODIMENT

The following discussion directed to a solar distillation system is merely exemplary in nature, and is in no way intended to limit the invention or its applications or uses. This design is preferred because of its simple construction and because it can be built with common materials.

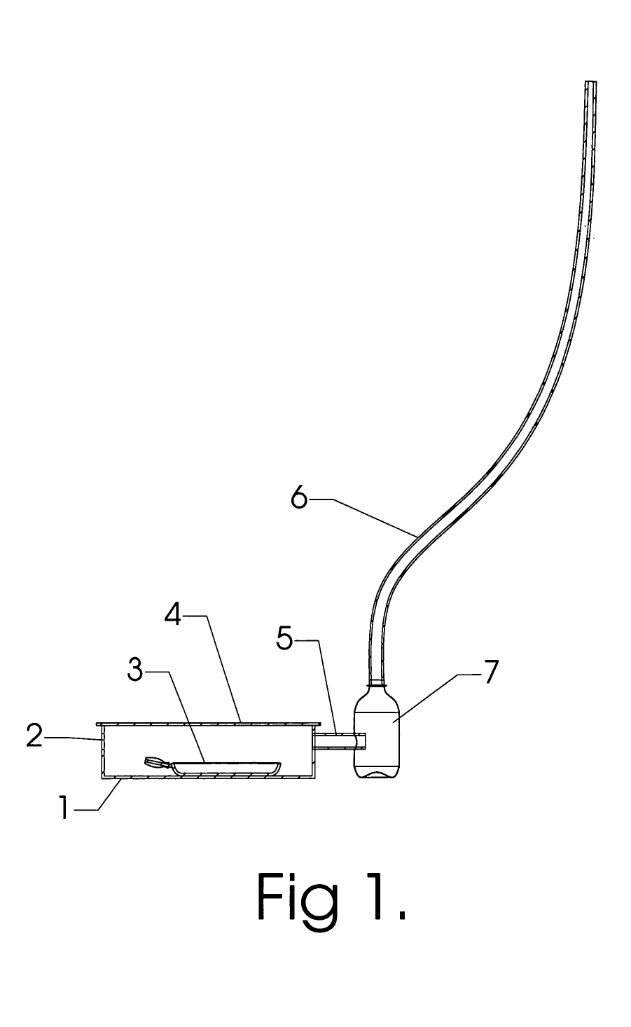

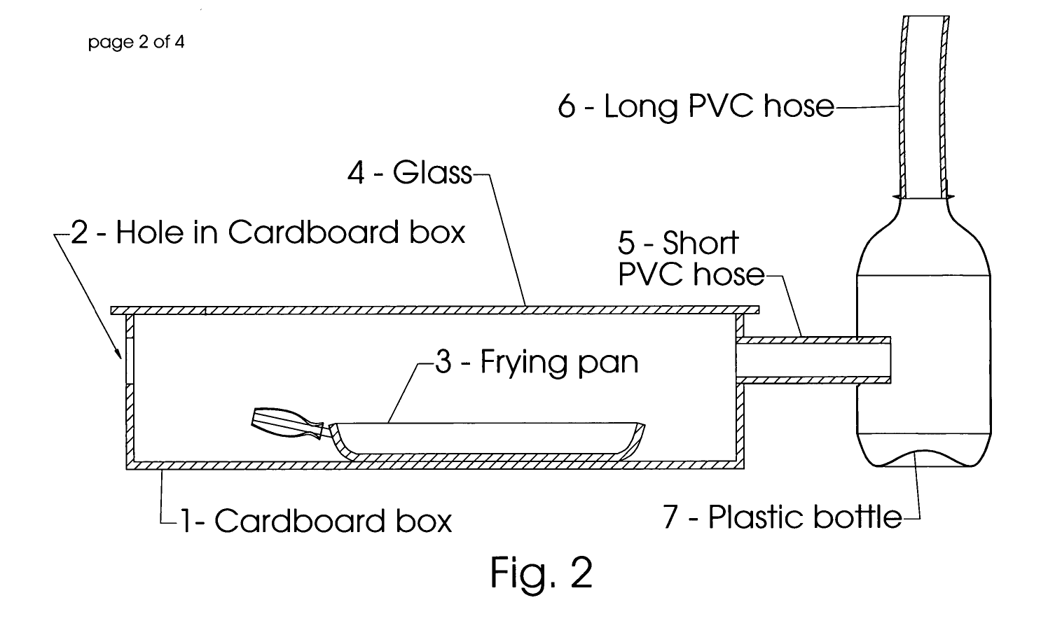

The invention comprises of three major parts; the evaporator, the condensate collector, and the condensing structure. Heat is applied to the evaporator to evaporate the liquid inside of it. The condensing structure is an upward sloping hose that warm humid air rises through and where vapor condenses. The condensate collector has is a container to hold the distilled liquid. It has a passageway that allows condensate from the condensation structure flow into it. Directions for constructing the preferred embodiment are given below. Please refer to FIGS. 1 and 2 to see what the preferred embodiment will resemble.

To build this particular design, you will need these materials:
A cardboard box (part 1)
A frying pan or other open top container that will fit in the cardboard box (part 3)
A piece of clear glass or clear plastic that is large enough to cover the open top of the box. (part 4)
A length of hose, preferably clear PVC hose, the longer the better. (part 6, a section of this will be cut to make part 5)
A plastic bottle, such as a two liter soda bottle (part 7)
A knife or box cutter
Tape
Water to be distilled

The evaporator here is a modified version of a solar oven. First, lay the cardboard box 1 on the ground with the open top up. Place the frying pan 3 in the box 1 to make sure can lie flat on the bottom of the box. Measure the height of the frying pan 3, and then cut the top of the box off to make the height of its walls a few centimeters above the height of the frying pan. Next cut two holes, on each in opposite walls of the box. One of these holes will be air inlet 2, and the other will be the hole that hose 5 fits in. The holes should be in opposite corners, so that they are as far away from each other as practical. One of the holes should have a diameter equal to the outside of the diameter of hose 5, so that hose 5 will fit snugly inside the hole.

Now place the frying pan 3 in the box 1 and fill it with water to be distilled. Place the sheet of glass or plastic 4 on top of the box 1 to cover the entire open top of the box. To make the connection between the top of the box 1 and the glass or plastic 4 closer to airtight, tape the two together along all edges. Construction of the evaporator is then finished.

Next, make the condensate collector from the plastic bottle 7. The plastic bottle 7 also needs two holes in it, one in the side, and one in the top. Both holes need to have a diameter equal to the outside diameter of hoses 5 and 6. When the holes are completed, the hose should be able to fit snugly in the holes. If hose 6 will fit snugly inside or around the opening top of the bottle 7, then attach the hose 6 there and use this instead of cutting a new hole in the top of the bottle 7.

Next cut off a short length of hose 6 and use it to make part 5. This part will connect the evaporator (parts 1, 2, 3, and 4) to the condensate collector 7. The length of hose 5 should be as short as practical but long enough to be able to move the condensate collector 7 to its desired place. Next, attach the longer length of hose 6 to fit snugly in the top of the condensate collector. Finally, find structure, tree, or any other tall object (not shown) to hang the top of the hose from. Arrange the hose so that its top end is as high above the evaporator as possible. Use tape or anything else handy to attach the hose to the structure. If the hose is tied around something, make sure that it is tied loosely and that there are no pinches in the hose, so that air may flow through the hose freely. Place the evaporator in the sun, and construction is complete.

### OPERATION OF INVENTION

The operation of the invention is simple; put the liquid to be distilled in the evaporator, and then heat the evaporator by putting it in sunlight or using another heat source. Air will flow through the invention as long as heat is applied to the evaporator. Liquid will be distilled as long as the evaporator is heated and there is liquid in the evaporator. The science behind the operation is described below, as well as methods for filling the distiller with water.

While this invention is operating, there is a continuous flow of air from outside the invention, through the evaporator, through the condensate collector, to the condensing structure, and finally to outside of the invention. No pumps or motorized devices are necessary to cause this airflow. The heat applied to the evaporator instead drives the airflow.

This invention utilized the concept that warm air rises. When the invention is running, there is warm air in the vertical or upward sloping condensing structure 6. The air inside the condensing structure is warmer than the air outside of the invention, and is therefore lighter. This causes the air inside the structure 6 to rise and pass through the condensing structure. As this air rises and exits the top of the condensing structure, air from the condensate collector 7 is sucked into the bottom of the condensing structure 6 to replace the air that left through the top of the structure. The air that enters the bottom of the structure is also warm, since it came through the evaporator before it entered the condensate collector. In this way, the warm air that rises out of the condensing structure is replaced by more warm air. This causes air to continuously flow through the invention as long as heat is applied to the evaporator to warm the incoming air.

To start the flow of air through the invention, the user simply needs to apply heat to the evaporator and wait. Once heat is applied to the evaporator, the air inside the evaporator will warm. Some of this warm air will diffuse out of the evaporator through the two holes in it; the air inlet 2 and the opening to the passageway 5 to condensate collector 7. The warm air that enters the condensate collector will rise to the top of the condensation collector and exit it. The air leaving the condensation collector will enter the condensation structure 6. To replace the air leaving the condensate collector 7, warm air from the evaporator will enter the condensate collector. To replace the air leaving the evaporator, cold air from outside the invention will enter the evaporator. This cold air will be warmed as it passes through the evaporator. In this way, all that is needed to start the airflow is to apply heat to the evaporator.

If there is salt water or any other volatile liquid in the evaporator while heat is applied to the evaporator, the liquid will evaporate. Air and vapor will continue to be warmed until their temperature is greater than the outside air temperature. The air and vapor will then be sucked into the condensate collector 7 and then into the condensing structure 6 as described above. In the condensing structure 6, heat energy will be transferred from the warm air and vapor to the relatively colder wall of the condensing structure. As energy is transferred from the vapor to the wall of the condensing structure, the vapor will condense and form droplets on the wall of the condensing structure. Droplets will grow to a size big enough to cause them to drip down the wall of the condensing structure into the condensate collector 7.

In order for condensation to collect, there must first be liquid in the evaporator. Liquid can be poured into the evaporator through any opening in the evaporator. It can be poured in through the air inlet 2. Hose 5 can be detached from the condensate collector 6, pushed most of the way into the evaporator so that it reaches over the frying pan 3, and water can be added through it. If the transparent material 4 is easily removable, it can be removed to allow access to the inside of the evaporator. Finally, any other opening can be added to the evaporator to allow liquid to be poured into it.

After the invention has been operating for an amount of time, condensate will collect at the bottom of the condensate collector. The condensate can be removed by detaching the condensate collector from the rest of the device and pouring out the condensed liquid into its desired location.

After several uses of the invention, solid precipitate will build up in the bottom of the evaporator where the liquid evaporates. When the volume of this distillate becomes large enough to prevent the desired amount of water from being put in the evaporator, it will need to be removed either by rinsing, scraping, or any of many other effective cleaning methods.

In summary, all that is needed to operate the invention is to input the desired liquid to be distilled into the evaporator, and apply heat to the evaporator. It will then be only a matter of time until condensation collects.

### Description and Operation of Alternative Embodiments

The major benefits of the preferred design over most other possible designs of the invention are: 1) the materials are common, 2) once supplies are gathered, it takes a small amount of time to construct. The preferred embodiment is the not the most energy or water efficient design that meets the description of the claims. There are several areas of the design that can be modified and several new parts that can be added to improve performance. These modifications and additions will be listed for the evaporator, then the condensate collector, and then the condensate structure.

The evaporator in the preferred embodiment is a solar oven with two added holes in it: an air inlet and an air outlet that is a passageway that allows air to get to the condensation structure. There are several published designs for solar ovens, as well as many designs that are commercially available. The amount of energy used towards the evaporation of the liquid to be distilled can be increased in many ways.

The three most significant ways to improve the performance of the evaporator are to:

1. increase the amount of energy used to evaporate the liquid,

2. minimize the amount of energy lost to the evaporators surroundings,

3. improve the evaporative characteristics of the design

Several methods using each of these concepts are explained below.

Increasing the amount of sunlight absorbed by a solar powered evaporator will improve its performance. Three ways to do this are:

Use mirrors or reflective materials to reflect sunlight into or onto the evaporator

Increase the area of the evaporator that is exposed to sunlight

Cover the evaporator with absorbent or dark colored paint or materials

Mirrors can be used to increase the amount of sunlight that reaches the evaporator. If flat mirrors are used, they may need to be repositioned several times over the course of the day to insure that they continue to reflect light into the evaporator.

A bigger evaporator can absorb more sunlight. Also, a bigger evaporator leaves more surface area for water to be exposed to air inside the evaporator, which improves the evaporative characteristics. The evaporator can also be tilted to get as much direct sunlight as possible. A plurality of evaporators can be used in parallel to increase the evaporator surface area. All of these evaporators can be connected to a common condensate collector and condensing structure, or multiple condensate collectors and condensing structures.

Finally, increasing the absorptivity of the material used to absorb sunlight can increase the amount of sunlight absorbed by the evaporator(s). Dark or black materials typically have high absorptivity. If paint is used to paint the inside of the evaporator, it should be non-volatile and non-toxic. Any volatile material in the evaporator has the potential to condense in the condensing structure and contaminate the water in the condensate collector.

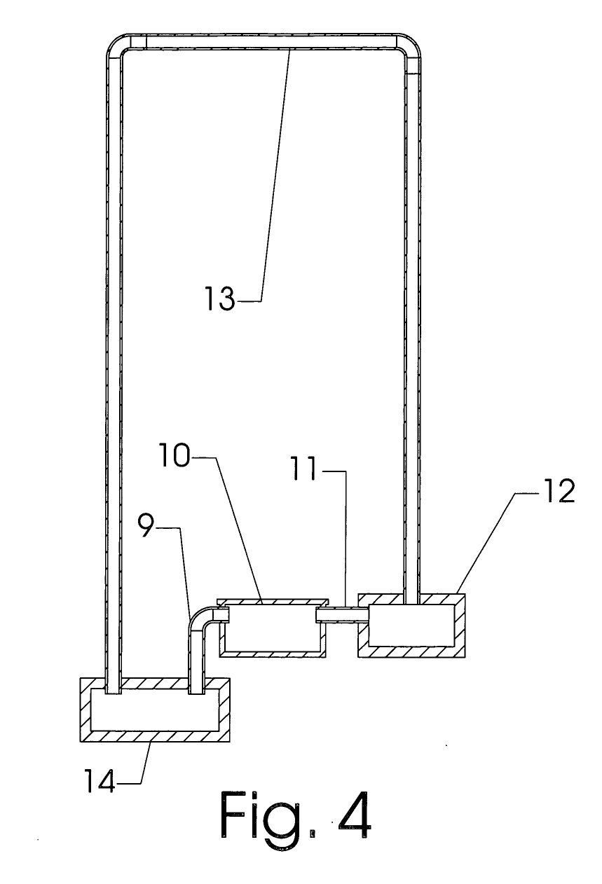

The amount of energy absorbed by the evaporators can be increase by means other than absorbing more sunlight. A major benefit of this device over other solar distillers is that it can run off of external heat sources. If the evaporator is non-flammable, in can be placed over an open flame. This can be valuable when water is needed at night or other low-light conditions. Smaller units may be able to run off of the heat from candles, sterno cans, or kerosene camping stoves. FIG. 4 shows a distiller that can be powered by a stove or open fire. In this case the evaporator is a kettle. A metal kettle 10 can be filled with water to be distilled and placed on a stove. When the kettle is heated, air will flow into the evaporator through pipe 9, into the kettle 10, then through a pipe 11 into a condensate collector 12, and through a copper pipe 13 used as a condensing structure. Using an external heat source to heat the evaporator is just one more way in which the amount of energy absorbed by the evaporator can be increased.

The performance of the evaporator can be improved by using the energy input into the evaporator more efficiently. Energy that enters the evaporator and is not used to heat the air or liquid inside of it exits the evaporator in three ways. Energy can be lost from the evaporator from conduction, convection, and radiation. Heat loss by conduction occurs when heat is transferred to objects in direct contact with the evaporator. Heat loss by convection occurs when heat is transferred to the air outside of the evaporator. Heat loss by radiation occurs because all objects constantly emit light, though the light may not be in a frequency visible to the human eye. All of these heat losses increase with an increase in evaporator temperature.

Insulating the evaporator can decrease the heat losses due to conduction and convection. The transparent or glass top of a solar evaporator can be double paned, and insulative material can be wrapped around the rest of the evaporator. One simple design of an insulated solar oven that can be used for an evaporator can be found on the website:

Keeping the evaporator out of the wind will minimize the amount of energy lost to convection. Ideally, the evaporator should be kept in a place with direct sunlight and without wind.

Finally one last way to use energy input into the evaporator more efficiently is to make sure that all heated air and vapor that leave the evaporator make it to the condensing structure. When the evaporator is first heated, air can exit the evaporator both through the air inlet and the passageway to the condensing structure. Once heated air reaches the condensing structure, it will rise and pull air through the distiller in the direction that air is intended to flow. Until that occurs, heated air can diffuse out of the evaporator through the air inlet. To prevent this from happening, a pipe 9 can be attached to the inlet. If the pipe's free end is lower than the air inlet, warm air will not fall through the pipe 9 since warm air has a tendency to rise. Therefore, pipe 9 can prevent hot air from escaping the evaporator when the evaporator is first heated.

The third area to increase the performance of the evaporator is to enhance the evaporation ability of the evaporator. The invention utilizes the concept that water evaporates into dry air quicker than it evaporates into humid air. The invention allows air to continually enter the evaporator. The water inside the evaporator is therefore exposed to moving air that is not already saturated with water vapor, and this increases evaporation rate. Increasing the surface area that water is exposed to air will also increase the evaporation rate.

The next part of the invention is the condensate collector. In essence, the condensate collector is the part of the device where condensate goes when it escapes the condensation structure. The goal of the condensate collector is to provide a passageway for condensate to flow out of the condensation structure and into somewhere where it can be useful. The condensate collector need not be a container. Rather, it could be a dropper that could allow water to drip into and puddle or external container that is not part of the invention.

There are several modifications that can make the condensate collector more effective and easy to use. First, there does not need to be a pipe 5 connecting the condensate collector 7 to the evaporator. Rather, the two could share a common wall. A hole in the wall could allow warm humid air to pass from the evaporator to the condensate collector.

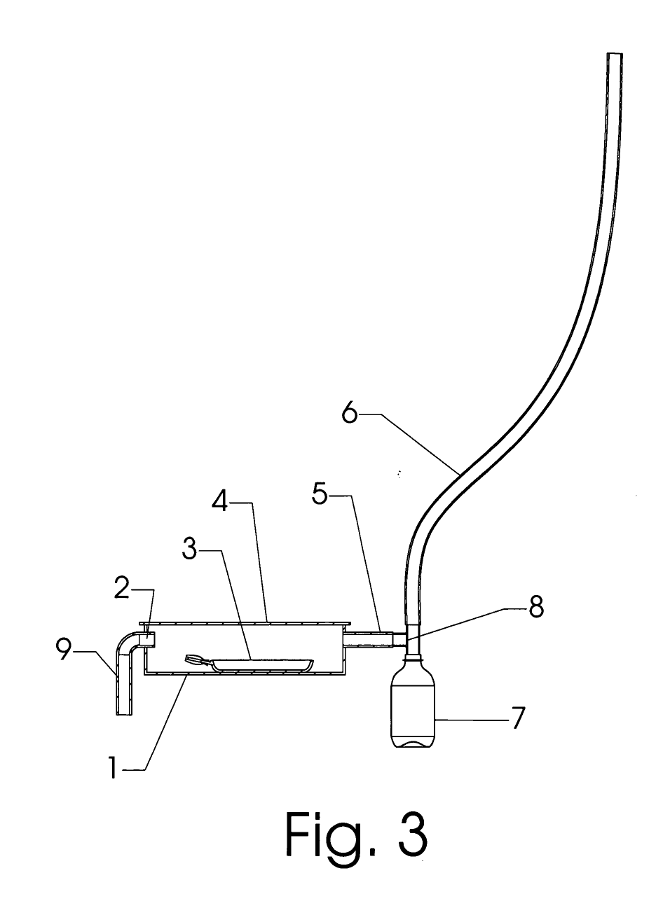

Second, air does not need to pass through the collection area of the condensate collector either. Air can bypass the collection area and enter the condensing structure directly, as seen in FIG. 3. A three-way pipe connector 8 can be used to connect the evaporator to the condensing structure 6 and allow a passageway for condensate to drip from the condensing structure 6 to the condensation collector 7. When all of the liquid in the evaporator dries up, dry air will continue to flow through the invention. Separating the condensed liquid from the airflow will prevent the condensed liquid from evaporating when all of the liquid in the evaporator is gone.

A spigot can be added to the condensate collector 7. This would allow the distilled liquid inside to be easily accessible.

A plurality of condensate collectors can be attached to a plurality of condensing structures. These condensing structures can be connected to one or more evaporators. This would allow condensed liquid to be collected even when one of the condensate collectors disconnected to remove its contents.

The third part of the distiller that can be improved or modified is the condensing structure. When the invention is operating, the condensing structure is filled with a column of air that is warmer and more humid than the ambient air. This column of warm humid air does two things; it rises through the condensing structure, and transfers heat energy to the condensing structure. As the air rises through the structure, it sucks air through the distiller. As the air in the condensing structure loses heat to the wall of the condensing structure, vapor condenses. There are essentially two areas where the performance of the condensing structure can be improved:

1. improving the heat transfer from the air inside the structure to the wall of the structure.

2. making it easier for air and vapor to flow through the structure,.

Some of the mathematics describing the heat transfer and then ways to improve heat transfer are described below.

Condensation occurs when heat energy is removed from humid air. For rapid condensation, the rate of heat transfer from humid air to its surroundings should be as great as possible. The rate of heat transfer from air to a solid body can be described by the equation:
Q=h*A*(Tair-Tbody)
where ‘Q’ is the rate of heat transfer in units of energy, ‘h’ is the convection coefficient in units of energy divided by unit area times unit of temperature, ‘A’ is the surface area where air is in contact with the solid body, ‘Tair’ is the temperature of the air, and ‘Tbody’ is the temperature of the of the body in contact with the air.

Compared to other distillers of comparable simplicity, the heat equation for the current design has a relatively high convection coefficient ‘h’, a high area ‘A’ of contact between the air and the condensing surface, and a lower temperature ‘Tbody’ of the condensation surface. This has the effect of increasing the heat transfer rate ‘Q’, which allows vapor to condense quicker.

In the invention, humid air is moving along the surface on which vapor condenses. Heat is transferred quicker to and from a surface to moving air faster than heat is transferred from stagnant air. In the above equation, the convection coefficient ‘h’ is higher for air that is moving than for stagnant air. Since air in the invention moves over the condensing surface, heat is transferred quicker from the air to the surface. This increases the rate of condensation.

The surface area ‘A’ in which the warm humid contacts the condensing surface can be cheaply increased. Vapor condenses onto a tall pipe, giving ample surface area for heat to be transferred.

Finally, the surface onto which vapor condenses is not heated, as it is in many other designs. This means that ‘Tbody’ in the heat equation is lower than that of other designs, further aiding heat transfer and condensation.

Further study of heat transfer leads to several ways to modify the condensing structure to improve its condensing ability. The heat transfer characteristics of the condensing structure depend largely on the shape, size, and material of the condensing structure, as well as the conditions in which the condensing structure is placed. In order to maximize the heat transfer ability of the condensing structure, several things can be done:
increase the surface area of the structure
make the structure out of a material with high thermal conductivity (such as metal)
use the thinnest walls possible
place the structure in a shaded area
place the structure in a windy area
use a transparent or translucent structure
if the structure is not transparent, paint the outside of the structure white so it absorbs less light
   Copper pipes are commonly inexpensive, have high thermal conductivity, and thin walls. For these reasons, they make excellent condensing structures.

The second major way to improve the performance of the condensing structure is to make it easier for air and vapor to flow through it. Air flows through the distiller because warm humid air is lighter and less dense than cold dry air. Buoyancy forces cause warm humid air to rise in cold dry air. It is these buoyancy forces that cause air to flow through the distiller. The amount of work that the buoyancy forces can do to cause airflow depends on three things:
(i) the difference in height between the top and the bottom if of the condensation structure,
(ii) the cross sectional area of the condensation structure,
(iii) the difference between the density of the air inside the condensation structure and the air above the air inlet to the evaporator.
   Airflow can be increased by increasing all three of the above values. The way each of these can be increased is described in the three next paragraphs.

The higher the top of the structure is over the inlet of the structure, the faster air will flow through the invention. Air at the bottom of the structure is at a lower pressure than air at the same height outside of the invention. This is because the air at the bottom of the structure is under a column of warm light air rather than cold heavy air. It is this pressure difference that drives air from outside the invention, through the evaporator and condensate collector into the condensing structure. A greater distance between the bottom and top of the condensing structure causes a greater pressure difference between the air outside the invention and the air under the condensing structure. Generally, a taller condensation structure will lead to faster airflow through the invention. A taller condensation structure also increases the area onto which vapor can condense. Generally, a taller condensation structure is better than a shorter condensation structure because it increases airflow and allows more surface area for vapor to condense on.

For a given height of condensing structure, a larger cross sectional area will mean that there is less resistance to airflow. The walls of the structure will exert less drag on the air. Multiple condensation structures can be used to increase the total cross-sectional area of the condensing structures while keeping a large surface area for vapor to condense on.

The third way to increase airflow is to make the air in the condensing structure less dense. The evaporator does this job by heating the air and making it more humid. The hotter and more humid the air coming out of the evaporator, the faster air will flow through the distiller.

There are many other alternative embodiments, some of which are described below. One of these collects condensate that forms inside the evaporator. When operating a solar powered evaporator, the user may notice that water will condense on the transparent top of the evaporator. Previous designs captured only water that condensed on this transparent top. The distiller described in this specification can be built to collect condensate from the transparent top of the evaporator and condensate from the condensing structure. If glass is used for the transparent material in the solar evaporator, the glass can be tilted in a way that would allow water that collects on the bottom side of the glass to drip directly into the condensate collector, or into a pipe connected to the condensate collector.

In all previously mentioned designs, some vapor and heat energy exit the distiller through the air outlet of the condensing structure. This energy and vapor can be prevented from escaping by re-circulating the air exiting the condensing structure to the evaporator. Air that exits the condensing structure can be re-circulated into the evaporator. If water conservation is of essential need, the condensation structure 13 can be extended to allow air to flow all the way to the air inlet. This is shown in FIG. 4. In this design, air and vapor flow counter-clockwise through the invention. The air and vapor on the right side of the condensation structure are warmer and less dense than the air on the left side of the condensation structure. Therefore, the air on the left side of the structure wants to fall while the air on the right side of the structure rises. A second condensation collector 14 can be added to collect any condensation that forms on the left side of the condensation structure 13. There is nowhere for vapor to escape the system. Any vapor that doesn't condense in the condensation structure will be re-circulated through the evaporator and condensation structure again. A pipe or hose 9 with a sufficient height change close to the evaporator will insure that air and vapor start flowing in the correct direction when the evaporator is first heated.

The re-circulating design has several advantages. In this design, no uncondensed vapor exits the distiller. There is also self-induced airflow that aids in heat transfer. There can be a large condensing surface area that will further aid in heat transfer. Finally, for a given amount of heat energy input into the evaporator, the evaporator will have a lower temperature due to the airflow. This will lead to less convective, conductive, and radiation heat losses from the evaporator than in other types of distillers. This means that more of the energy input into the evaporator can be used to vaporize liquid.

Several modifications can be added to the re-circulating design. Three possible design modifications are:
Using a small hole to open the inside of the distiller to the atmosphere to prevent excessive pressure from building up inside the distiller as liquid evaporates.
Using a vacuum pump to lessen the pressure within the distiller, allowing the liquid to be distilled to boil at a lower temperature.
Using external means to cool the area of the condensation structure where air flows downward, thereby condensing more liquid. This would increasethe density of the cold air, which would increase the rate of airflow through the distiller.

The distiller design may be promising for large-scale seawater desalinization projects. An example of a large-scale distiller is given in this paragraph. This distiller would have a transparent top that encloses an area of flooded ground and a volume of air. One area of this world that this concept may be ideally suited for is the area along the north coast of the Gulf of California in Mexico. This region is an arid desert along the ocean. In certain areas there are salt flats within several hundred meters of the ocean. Some of theses salt flats may be below sea level. A glass roof can be built over these salt flats. Ocean water can be siphoned onto the glass-covered salt flat. The sun will heat the seawater under the glass. Air will be sucked into the evaporator and will pass over the solar heated seawater. The seawater will evaporate into the air, leaving the salt behind to be deposited on the salt flat. The air will then be sucked into a condensation structure, where water vapor will cool and condense. Fresh water that condenses in the condensation structure will drip into a fresh water container.

As seawater over the salt flat dries up, it will automatically be replaced by water from the siphon. The siphon will keep the salt flat filled with water up to ocean level, making the distiller self-filling. The salt and solid matter that is left from the evaporation of water will sink to the bottom and be deposited on top of the salt flat. The salt will never need to be removed from the evaporator, and the evaporator will be self-filling.

Conclusions, Ramifications, and Scope:

The reader of the specification can see that distillers that meet the description of the claims can be built in a wide range of sizes with a wide range of common materials. These distillers can be powered either by sunlight or by other heat sources. Heat applied to the evaporator causes a density difference between air entering and exiting the evaporator. This difference in density is used to cause airflow through the distiller. No pumps or electrical devices are necessary for operation, making the design relatively simple. The simplicity of the invention allows it to be built easily and inexpensively.

The design for the distiller is versatile, allowing for a plethora of embodiments. Many examples of different embodiments are given in the specification. These examples are intended to help describe different design concepts, and not to limit the scope of the invention. The scope of the invention should be limited only by the claims.

Sequence Listing—Not Applicable

I claim:

1. A device capable of distilling volatile liquids comprising
(a) an evaporator that contains a heated liquid to be distilled and has an air inlet through which air can enter said evaporator and flow over said liquid, allowing said liquid to evaporate thereby creating a mixture of vapor and said air with a greater temperature and lesser density than that of said air entering said evaporator,
(b) a condensing structure that has (i) an open passageway connecting it to said evaporator that allows said mixture of air and vapor to flow into said condensing structure, (ii) surface area on the inside of said condensing structure onto which the vapor can condense to form condensation, (iii) a section through which said air and said vapor can rise due to buoyancy forces, thereby causing airflow through the distilling device, (iv) an outlet to let said mixture of vapor and air to exit said condensation structure,
(c) a passageway through which said condensation can flow downward to a region separate from said liquid to be distilled.

2. The distillation system of claim 1 in which said evaporator is an opaque container with a transparent top that allows sunlight to enter said evaporator to heat said liquid to be distilled.

3. The distillation system of claim 1 in which the evaporator absorbs heat from an external energy source.

4. The distillation system of claim 1 where a plurality of evaporators are used.

5. The distillation system of claim 1 where said evaporator has inner surfaces that are tilted in a manner that allows condensation that forms on said inner surfaces to drip into an area separate from said liquid to be distilled.

6. The distillation system of claim 1 where said region separate from said liquid to be distilled is inside a container.

7. The distillation system of claim 6 where said mixture of air and vapor flows from said evaporator, through said container, and into said condensing structure.

8. The distillation system of claim 1 where said condensing structure is a hollow cylinder.

9. The distillation system of claim 1 where said outlet to said condensing structure connects to said air inlet of said evaporator.

10. A device capable of distilling volatile liquids comprising:
(a) an evaporator with an air inlet that allows incoming air to flow over a heated liquid to be distilled, thereby warming said air and allowing said liquid to evaporate into said air, creating a mixture of air and vapor with a greater temperature and a lesser density than said air had before flowing over said liquid to be distilled,
(b) a hollow condensing structure through which said mixture of air and vapor can rise through due to buoyancy forces and exit through an outlet, said mixture having a higher temperature than said condensing structure allowing heat energy to be transferred from said air to said condensing structure, thereby allowing some of said vapor form condensation on inner surface area of said condensing structure,
(c) a connection between said evaporator and said condensing structure allowing said mixture of air and vapor to pass from said evaporator into said condensing structure, whereby buoyancy forces on said air and said vapor in said condensing structure can maintain airflow continuously without the need for a pump,
(d) a passageway through which said condensation can fall from said inner surface of said condensing structure into a region separate from said liquid to be distilled.

11. The distillation system of claim 10 where a plurality of evaporators are used.

12. The distillation system of claim 10 in which the evaporator absorbs heat from an external energy source.

13. The distillation system of claim 10 in which said evaporator is an opaque container with a transparent top that allows sunlight to enter said evaporator to heat said liquid to be distilled.

14. The distillation system of claim 10 where said evaporator has inner surfaces that are tilted in a manner that allows condensation that forms on said inner surfaces of evaporator to drip into an area separate from said liquid to be distilled.

15. The distillation system of claim 10 where said region separate from said liquid to be distilled is inside a container.

16. The distillation system of claim 15 where said mixture of air and vapor flows from said evaporator, through said container, and into said condensing structure.

17. The distillation system of claim 10 where said condensing structure is a hollow cylinder.

18. The distillation system of claim 10 where said outlet to said condensing structure connects to said air inlet of said evaporator.
